(19) United States
(12) Patent Application Publication
(10) Pub. No.: US 2022/0108031 A1
(43) Pub. Date: Apr. 7, 2022

(54) Cloud Core Architecture for Managing Data Privacy

(71) Applicant: Acxiom LLC, Conway, AR (US)

(72) Inventors: Vineet Kumar Saini, Conway, AR (US); John Riewerts, Argyle, TX (US)

(21) Appl. No.: 17/430,397

(22) PCT Filed: Dec. 1, 2020
(86) PCT No.: PCT/US2020/062643

§ 371 Date: Aug. 12, 2021

Related U.S. Application Data
(60) Provisional application No. 62/943,082, filed on Dec. 3, 2019.

(51) Int. Cl. G06F 21/62

(52) U.S. Cl. CPC G06F 21/62

(57) ABSTRACT

A cloud computing architecture for managing data privacy includes multiple cloud cores for the segregation of data sets. The data sets may be segregated by, for example, client or line of business. Identified and de-identified data is segregated and provided different access authorizations through a corresponding compute cluster. Each core may be managed through a separate cloud account. Cores corresponding to data collected in different regions are physically hosted in the corresponding regions, such that the architecture cloud cores are at known physical locations rather than anonymously hosted. Likewise, applications specific to a region and used for processing of data in that region are physically hosted in that region in conjunction with the corresponding data.

This application claims the benefit of U.S. provisional patent application No. 62/943,082, entitled “Cloud Core Architecture for Managing Data Privacy,” filed on Dec. 3, 2019. Such application is incorporated herein by reference in its entirety.

### BACKGROUND OF THE INVENTION

Retailers and marketers today spend large sums of money building marketing databases, with these databases oftentimes containing data records pertaining to many millions—perhaps hundreds of millions—of consumers. In the case of retailers, these databases may contain “first-party” data, i.e., data that has been provided directly to the retailer by its customers as part of a transaction with the retailer. These retailers and marketers may work with marketing service providers to maintain, store, and/or manage the large amount of data records associated with their customers. They may also augment the data they already have with “third-party” data, i.e., data that is not acquired directly from the customer of a retailer, but is rather provided by a marketing services provider or other provider of consumer lists and databases to the retailer or other such party. In some cases, this third-party data may include records for consumers that are not customers of the retailer and thus already in its databases, in which case the data may in certain instances be considered prospect data. The data may also include additional data fields about consumers that are already within the retailer's database, sometimes referred to as enhancement data. For example, a retailer who sells automobiles may be interested in enhancement data indicating whether a particular consumer is likely to be in the market for a new vehicle.

Some marketing services providers and other data providers maintain comprehensive consumer databases that track hundreds or even thousands of data fields pertaining to tens or hundreds of millions of individual consumers or households. These databases, by their very nature, require immense storage capacity. Likewise, the analysis that is performed in order to activate and effectively utilize such enormous amounts of data requires extremely large input/output bandwidth and computational processing capacity. The same problems arise when a marketing services provider is maintaining data for its clients, or is managing both its own comprehensive consumer databases and client data. The rise in the amount of data that is available has, in many instances, greatly outstripped the ability of those who maintain the data to effectively utilize the data, thereby reducing the effectiveness of their efforts to leverage this data into increased business opportunities.

Implementing computing systems that manage large quantities of consumer data and/or service large numbers of users of such data presents problems of scale. As demand for various types of computing services grows, it may become difficult for marketing services provider to manage this data with its own internal computing infrastructure. Maintaining these resources internally means that the marketing services provider must always have sufficient data storage space in order to expand its databases to include newly acquired data, which can result in excess and thus unused storage space, which is a waste of computational resources. Likewise, in order to ensure that peak input/output bandwidth and computational capacity requirements are met, the marketing services provider must maintain sufficient computational infrastructure to meet this peak demand at all times, but necessarily this additional capacity will sit partially idle when peak capacity is not required, again amounting to a waste of resources. For example, to facilitate scaling to meet demand, many computing-related systems or services are implemented as distributed applications, each application being executed on a number of computer hardware servers. In another example, a number of different software processes executing on different computer systems may operate cooperatively to implement a computing service. When more service capacity is needed, additional hardware or software resources may be deployed to increase the availability of the computing service. But as demand decreases, these additional hardware resources sit idle, thus amounting to a waste of resources that are expensive to acquire and to maintain.

Today's availability of high-speed, high-capacity electronic communications networks (including the Internet), low-cost commodity-type computer servers and storage devices, and the widespread adoption of hardware virtualization such as in computer clusters, service-oriented hardware and software architecture, and autonomic and utility computing has led to enormous growth in cloud computing. Cloud computing is the on-demand availability of computer system resources, especially data storage and computing power, without direct active management by the user of the computing resources. The term is generally used to describe data centers available to many users over the Internet, although the cloud may be public clouds that numerous parties use, private clouds allocated to a single user, or a hybrid cloud approach. Large clouds, predominant today, often have functions distributed over multiple locations from central servers. Cloud computing relies on sharing of resources to achieve coherence and economies of scale. Cloud computing also may relieve the user of the need for a deep knowledge and or expertise about the individual hardware and software components of the cloud, freeing the user to benefit from the technologies and concentrate on building and utilizing applications specific to its business model. This allows the user, such as a marketing services provider, to curtail its costs by eliminating the need for it to purchase, build out, and maintain its own compute infrastructure. Instead, the marketing services provider needs only to have a front-end system in order to access the data and/or applications that are executing in the cloud, and thus “virtualize” the compute environment for itself. In some applications, the user may need nothing more than a web browser in order to take advantage of cloud computing resources. Virtualization software separates the user from concern about individual physical computing devices to concentrate on the use of virtual devices, which may be a portion of a single physical device or may be implemented as many separate physical devices operating together, whether in close physical proximity or located far apart and connected by high-speed electronic networks. In the most extreme cases this may lead to a “serverless” computing model, in which the cloud computing provider fully manages starting and stopping virtual machines as necessary in order to serve user requests, and both physical and virtual machines are transparent to the end user.

Advocates of public and hybrid clouds note that cloud computing allows companies to avoid or minimize up-front compute infrastructure costs. Proponents also claim that cloud computing allows enterprises to get their applications up and running faster, with improved manageability and less maintenance, and that it enables information technology infrastructure teams to more rapidly adjust resources to meet fluctuating and unpredictable demand. In this model, the marketing service provider manages a very large database or datastore that stores the data records for up to an unlimited number of individual clients, each of whom may provide vast amounts of data to the marketing services provider. Another advantage of cloud computing is the potential for enhanced reliability, as the actual physical components of the system may be located at multiple redundant sites, providing improved business continuity and disaster recovery. The provider of the cloud computing resources may concentrate its technical expertise in these areas, whereas the user may concentrate its expertise on use of the data and applications placed in the cloud.

Public cloud computing is often priced on the basis of use, such that the cost depends upon the resources that are actually allocated to the user at any given time. This on-demand pricing model is advantageous for many users, particularly those that may have heavy computing power needs for short periods of time, but at other times may have far lower computing power needs or no needs at all. Thus a capital expenditure, such as buying computer servers and storage devices, is converted to an operational expenditure from the point of view of the cloud computing user. In the serverless cloud computing model, computational requests may be billed by an abstract measure of the resources required to satisfy the request, rather than per virtual machine per hour, further abstracting the cost from the underlying hardware and providing greater flexibility to the user.

As concerns about privacy increase and the monetary value of data continues to grow, the ability to protect client data is of utmost importance when clients choose to develop business relationships with marketing service providers. Cloud storage presents particular issues and problems with respect to the protection of client data. Cloud computing poses privacy concerns because the service provider can theoretically access the data that is in the cloud at any time; this follows from the fact that it is the cloud computing provider, not the marketing services provider or other user, who physically houses and maintains the computing hardware providing the cloud computing capability. The cloud provider could accidentally or deliberately alter or delete information. Many cloud providers can share or are required to share information with third parties under laws applicable in various jurisdictions. As one measure of protection, users can encrypt their data that is processed or stored within the cloud to prevent unauthorized access. Identity management systems can also provide practical solutions to privacy concerns in cloud computing. These systems distinguish between authorized and unauthorized users and determine the amount of data that is accessible to each entity. The systems work by creating and describing identities, recording activities, and deleting unused identities.

Marketing services providers must be extremely sensitive to the privacy of the data they maintain and process because this data includes personally identifiable information (PII). PII can include, for example, names, addresses, email addresses, and other information that can be used to identify a particular individual. There exists today a large patchwork of laws, regulations, and rules that govern the measures that a marketing services provider must employ in order to safeguard PII of the consumers about whom it maintains data. Significant legal frameworks include the General Data Protection Regulation (GDPR) applicable in the European Union, and the California Consumer Privacy Act (CCPA) applicable to residents of the State of California. A marketing services provider must ensure that it adheres to these legal requirements, and must also consider the possibility of future legal requirements that may be implemented. Ethical marketing services providers will also adhere to best practices for the protection of PII as have been promulgated by various industry groups and trade organizations. The many legal and extra-legal requirements applicable to marketing services providers, as entities that must safeguard PII, has greatly hampered the adoption of cloud computing within the industry due to the concerns about privacy of PII that is maintained in the cloud, and concerns about commingling of data from different clients. In addition, the fact that the physical location of servers is often unknown in a cloud computing environment is incompatible with certain requirements of the GDPR, which regulates, among other things, the geographic location where data concerning European Union residents may be physically stored.

According to the Cloud Security Alliance, the top three threats in the cloud are Insecure Interfaces and API's, Data Loss & Leakage, and Hardware Failure—which accounted for 29%, 25% and 10% of all cloud security problems, respectively. Together, these form shared technology vulnerabilities. In a cloud provider platform being shared by different users there may be a possibility that information belonging to different customers resides on the same data server. There is significant concern that hackers are spending substantial time and effort looking for ways to penetrate the cloud. Because data from hundreds or thousands of companies can be stored on large cloud servers, hackers can theoretically gain control of huge stores of information through a single attack.

Currently there are a number of commercial cloud storage solutions, but one of the leading cloud platforms is Amazon Web Services (AWS), which offers a variety of cloud computing services. AWS boasts that it has the largest and most dynamic cloud ecosystem, with millions of active customers and tens of thousands of partners globally. AWS allows for the secure storage of files and data on the cloud, accessible from anywhere with an Internet connection. In order to access the services offered and the data stored, an AWS account accessible by the particular user (such as the marketing services provider) is associated with the particular services and data. The AWS account owner is given access to and control of the data associated with the particular AWS account. To upload data to AWS, an S3 bucket is created and any number of objects can be uploaded to that bucket. S3 refers to the Amazon Simple Storage Service, which provides object storage services in the AWS environment. AWS allows for the pre-authorized creation of up to one hundred S3 buckets per AWS account, but that number can be increased with AWS permission.

For organizations like marketing services providers who work with many clients, a single AWS account associated with the marketing service provider may have access to the data of many different clients. The AWS Landing Zone service allows for the creation of a multi-account AWS environment. Existing data management for this scenario, where a single marketing service provider has access to the data of many different clients, results in a single AWS account associated with the marketing service provider giving full access to all of the client data of that account to any person who has administrative access to the AWS shared multi-client account. This causes serious security concerns because someone who needs only data for a single particular client may gain access to data for all other clients in the environment. In addition, this approach risks comingling of separate client data. Just as the PII in the client data must be protected from disclosure to the general public, the data of one client must be protected from disclosure to another client. A consumer that has consented to provide its data to a particular retailer or other client of the marketing services provider likely has not consented, depending upon the terms of service and privacy policy in effect, to provide that data to other retailers or marketing service provider clients. In some cases, the other client may even be a competitor of the client to whom the data belongs, in which case the commingling of data would be disastrous for both the consumers impacted and the client of the marketing services provider whose data was inadvertently shared. One solution would be to simply maintain entirely separate AWS accounts for every client. However, creating separate AWS accounts for each client may not be feasible, because while the individual client data should not be comingled, there are shared services or application programs that process client data, and therefore the client data of all clients must be accessible by the shared services or application programs.

A marketing services provider may implement a Unified Data Layer (UDL) to activate the data it maintains for its clients. A UDL is an open, trusted data framework for creating an omnichannel view of customers and connecting the cloud-based ecosystem. In addition to the necessity to eliminate the risk of comingling separate clients' data, it is typical that in some cases, a single client may have multiple lines of business that operate in different countries or regions. Because there may be different privacy laws and regulations in different regions or countries, the inventors hereof have recognized that it may also be necessary to separate and manage a single client's data based on area or region where the data is collected. The abstraction that is generally an inherent advantage of cloud computing architectures thus creates an obstacle for the use of a cloud computing environment for the storage, management, and utilization of certain types of data.

It would thus be desirable to develop a cloud computing architecture that leverages the advantages of a cloud computing environment, but that overcomes certain of the challenges of cloud computing environments including the concerns about privacy and commingling of data, and adherence to legal and extra-legal requirements concerning geographical situs and other aspects of data storage and use.

### SUMMARY OF THE INVENTION

Generally speaking, the present invention is directed to a system architecture or platform that allows for the segregation of data/resources associated with multiple different clients or of data/resources associated with multiple business lines of a single client (or some combination thereof) in a cloud computing environment with specificity of geographical location of resources. The present invention enables the implementation of a UDL in a cloud environment, including cloud environments such as but not limited to AWS, and integration with data processing platforms (such as Qubole) for resource management and analytics, which further can be extended to GCP/Azure and other cloud providers. The present invention allows the UDL to run in the cloud and allows for onboarding of UDL client in, within the context of certain implementations of the invention, a matter of minutes as opposed to, for example, months. Certain implementations may include the automation of the setup/configuration process and provide the benefit of cloud services with an extended number of resources based on demand, all in a dynamic fashion. This approach makes the UDL platform a highly efficient and high performing “big data” platform. The architecture of the present invention thus allows for the advantages of cloud computing while also providing the necessary privacy protections inherent to such computing applications.

In certain implementations, the present invention allows for the management of client data from multiple individual clients without the improper comingling of such data. Furthermore, certain implementations allow for the segregation of a single client's data based on region or line of business under the same client such that the client may remain in compliance with different privacy regulations of different regions, all still within a cloud computing environment in order to achieve the cost savings associated with this distributed computing approach.

### BRIEF DESCRIPTION OF THE SEVERAL VIEWS OF THE DRAWINGS

FIG. 1 is an overall system diagram according to an implementation of the present invention.

FIG. 2 is an example access management table according to an implementation of the present invention.

FIG. 3 is an example compute management platform according to an implementation of the present invention.

FIG. 4 is an example of a partner applications set according to an implementation of the present invention.

FIG. 5 is an example of an object datastore stored in a cloud environment according to an implementation of the present invention.

FIG. 6 is an example of logs and resources stored in a cloud environment according to an implementation of the present invention.

FIG. 7 is a computer system diagram according to an implementation of the present invention.

### DETAILED DESCRIPTION

For purposes of describing the invention, a “client” is the owner of one or more data records (and most likely millions of data records). Generally, the data records may contain information associated with one or more consumers. This information may include personally identifiable information (PII) about the consumers.

The term “data master” refers to a person or entity (such as, for example, a marketing services provider) whose obligations including storing, managing, or processing the data of multiple clients. Thus, it may be seen that a data master has access to or otherwise controls an extremely large amount of client data, portions of which belong to individual clients.

A “core” as used herein is a logically differentiated region of storage, which may be specific to a line of business for a client of a data master, which allows for the segregation of computing resources and data storage. A cloud core is a core allocated in cloud storage to provide dedicated resources for a core with 100% throughput utilizing per pay use and preferably scale on demand. The cloud core allows for the segregation of computing resources and data storage by country or region. This creates an opportunity to support a uniform data layer (UDL) even in a country or region where a private data center operated by the data master does not exist.

A “data group” as used herein is a data grouping or category that may be based on various criteria, such as the type of data, the privacy rules for the data (identified or deidentified), or the like. It may be the basis for authorizing access to the associated data, and used to control who can access what data type, thereby serving to enforce applicable privacy laws, rules, and best practices.

A system according to an implementation of the invention allows for the management of client data from multiple individual clients without the improper comingling of such data. Furthermore, such system allows for the segregation of a single client's data based on region or line of business under the same client such that the client may remain in compliance with different privacy regulations of different jurisdictions or regions. To accomplish these goals, the system utilizes UDL cloud cores for each of the different segregated data sets. The data/resources for different clients are segregated and the data/resources for different clients with multiple lines of business can be segregated as well. For example, consider the case of a client who is a retailer with operations both in the United States and the European Union. If Client A has two separate lines of businesses as US-Brand A and EU-Brand A, each line of business may have identified and deidentified data type (categorized by privacy). Identified data is that data that contains personally identifiable information (PII), while deidentified data is that data where all PII has been removed. This data may also be known as anonymized data. The data may be segregated and handled with two different cores (UDL-cloud) and each core has a dedicated public cloud account (AWS for example). Thus, in this example, US-Brand A will be one core and EU-Brand A will be a different core. The US-Brand A core is physically hosted in the US geographical region only, which means it gets a dedicated cloud service provider account in the U.S. region. This dedicated cloud account is used for this core only for data storage and computing resources to process data. All data in the cloud storage is tagged by type based on a privacy rule (for example, may be tagged as identified/deidentified). Any access to identified/deidentified data is managed through a separate dedicated account. These accounts may be managed by third-party platforms that facilitate management of large data sets in the cloud, such as provided by Qubole of Santa Clara, Calif. In this example, the US data is handled by a Qubole account in the US region only and based on privacy rules (such as identified/deidentified data) as applicable to this type of data. Access to data is managed through roles and policies. The Qubole platform may be used as an analytics application for the client to access core-specific data, with a number of dedicated accounts for which access is given to a subset of data as governed by the applicable identified or deidentified privacy rules. The EU-Brand A core is set up similarly except that it has a dedicated cloud account created and managed in the EU region, allowing the client to satisfy GDPR requirements concerning locality of data storage. Thus, the ability for each core to be managed by a dedicated account in the region corresponding to that client (or line of business) not only allows for better compliance with region-specific regulations but also allows for privacy across multiple clients and/or multiple lines of business of a single client.

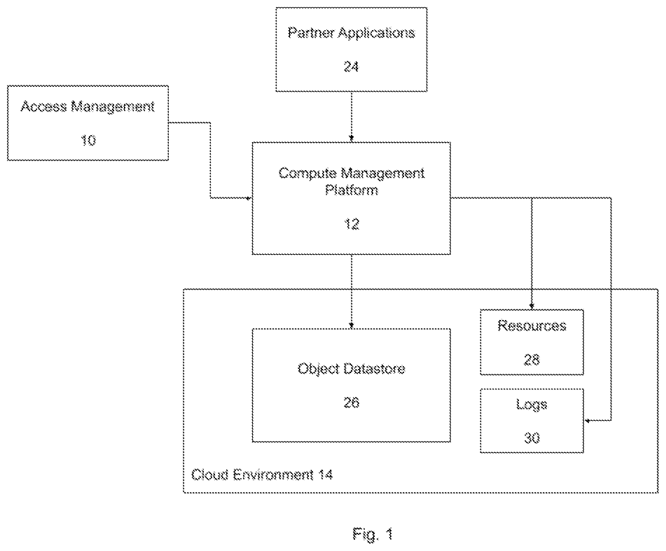

A specific implementation of the architecture described herein may be understood with reference to FIG. 1. At access management routine 10, information is stored about the authorized users of the system and the various types of access each user is granted. This prevents unauthorized access to system data at a highly granular level. It is another privacy safeguard in the system, since each authorized user can only access data that the user has a need to access. It also facilitates management of data in the system that is geographically bifurcated. As further described below, user access may be defined based on, among other things, particular clients, particular brands for each client, identified or de-identified data, and geographic location of the data.

Each data master user, once access is granted, accesses the system through compute management platform 12. Compute management platform 12 may be implemented as a single machine or multiple machines executing specially programmed software that provides a front-end to the portions of the system that are contained within cloud environment 14. Compute management platform 12 grants access to particular users according to the data provided from access management 10.

One or more partner applications at block 24 are granted access to client A data through compute management platform 12. This allows a single instantiation of each partner application to be used with respect to all data stored in the system. Any number of apps may be granted access through partner applications 24 in various implementations of the invention. Access to the data is controlled based on applications associated to a core (for example, a US core or an EU core) in cloud environment 14, and further may be based on privacy data groups, that is, identified data or deidentified data. Partner applications 24 may be implemented as a shared application instance, or could be a separate application installation per client/core or even a shared application with dedicated accounts.

Within cloud environment 14 (i.e., resources stored in the cloud) are object datastore 26, resources 28, and logs 30. Actual client data is stored in cloud environment 14 as one or more cores based on data groups. This data may be segregated based on client, client brand, identified or de-identified data, or data that is collected about consumers in different geographic regions. Cores that pertain to data from a particular geographic region are stored in that region, and thus it will be understood that cloud environment 14 may encompass physical storage sites distributed across any number of geographical regions. Access management 10, operating through compute management platform 12, controls access to the cores in object datastore 26 so that only authorized users for each core are allowed to access the data in the corresponding core.

In addition to the cores in object datastore 26, cloud environment 14 also includes shared resources. For example, per-region logs are maintained for each geographical region at logs 30. In addition, synched object datastores for resources are stored at resources 28. Resources 28 is a read-only resource synched across all regions through a shared account, and used by cores from storage in the corresponding region. In this case, resources 28 are used across all supported regions, and thus they are synched across all of these regions maintained by the system with corresponding object datastores in other regional areas of cloud environment 14.

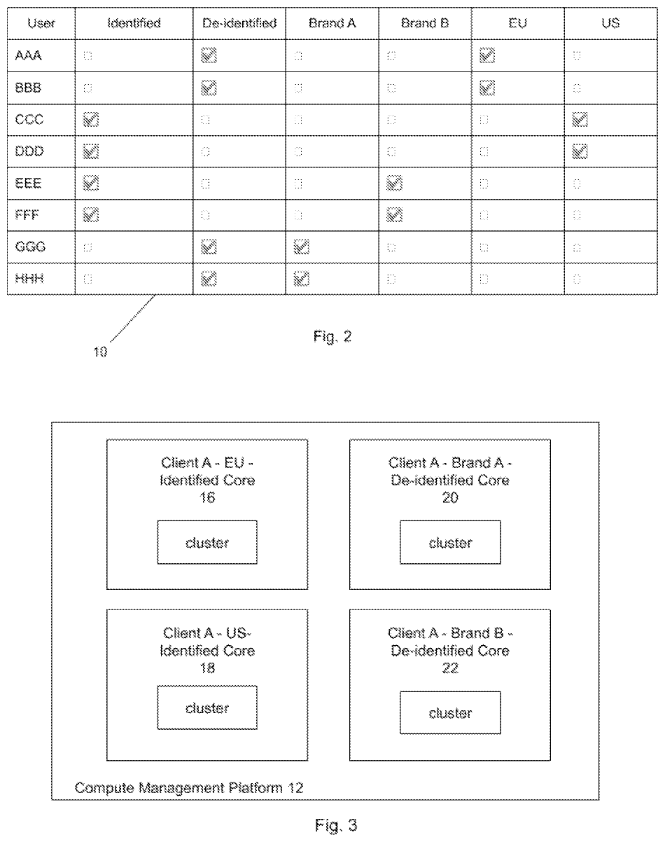

Referring now to FIG. 2, an example for a table used by access management 10 in order to control access to data within the system may be described. In this example there are eight users, AAA to HHH, but the system is applicable to any number of users as desired in a particular implementation. The users may be, for example, employees or contractors working for a data master administering the system as described herein. In the example of FIG. 2, it may be seen that user AAA has access to de-identified EU data for all brands. User BBB also has the same access privileges as user AAA. User CCC has access to only identified US data, as with user DDD. Users EEE and FFF have access to identified data for Brand B of a particular client, but not for Brand A. This access is across geographic regions. Users GGG and HHH, on the other hand, have access to de-identified data for Brand A of a particular client, but again this access is provided across geographic regions. Any other combination of particular access restrictions and privileges may be implemented as desired, in order to limit a particular user to access only the data that user requires in order to perform his or her job duties. In this way, data may be segregated along any of these criteria in order to minimize the possibility that privacy is compromised for the consumers about whom this data is maintained.

With reference to FIG. 3, an example configuration for compute management platform 12 may be described. It should be noted that these are only examples, and there may be as many different core control clusters as are necessary based on the data that is contained within object datastore 26. For illustrative purposes only, four different clusters are shown. In conjunction with the data provided by access management 10, the clusters in compute management platform 12 control access to the consumer data actually stored in object datastore 26. In this particular example, there are four clusters, each associated with a particular data group. Cluster 16 is for data pertaining to consumers of a particular client A, is specific to the EU geographical region, and is identified data. Cluster 18 is for data pertaining also to consumers of client A, and also pertains to identified data, but in this case is specific to the US geographical region. Cluster 20 is for data pertaining to consumers of client A again, but in this case the data access is organized differently than in the case of clusters 16 and 18. Here, the access is based on brands, with cluster 20 being specific to de-identified data related to Brand A for Client A, without regard to geographic region. Similarly, cluster 22 is specific to de-identified data related to Brand B for Client A, again without regard to geographic region. It may be understood from these examples that any combination of privileges or restrictions may be set up in a system that may contain any number of clusters in compute management platform 12.

Each data master user is granted access through compute management platform 12 according to data in access management 10, which in turn connects to cloud environment 14 as will be described below. In the illustrated example, user AAA has access through Client A's identified EU data group, implemented with cluster 16. As noted above, the data group is a data privacy group that defines the data type and also governs who has access to the data and how the data is persisted. User CCC has access through Client A's identified US data group, implemented with cluster 18. User GGG has access through Client A's Brand B deidentified data group, implemented with cluster 18. The data group associated with cluster 20, for Client A's Brand A de-identified data, is shown for completeness but does not correspond to a particular data master user in this abbreviated example.

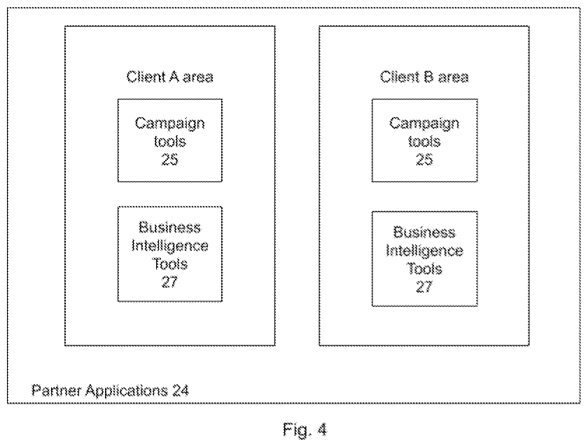

Various applications in partner applications 24 are granted access across all data for each particular client through compute management platform 12, as shown in FIG. 4. This allows a single instantiation of each application to be used with respect to all data stored in the overall system with respect to each client. In the example of FIG. 4, there are two applications, campaign tools 25 and business intelligence tools 27. Campaign tools 25 may be various software tools applicable to the building and implementation of a marketing campaign with respect to client A. Business intelligence tools 27 may be various software tools that apply analytics, data mining, digital dashboards, business activity monitoring, or the like. A separate instantiation of each of campaign tools 25 and business intelligence tools 27 is provided for each of clients A and B within partner applications 24 in order to keep separate the processing for these clients and thereby further safeguard against any commingling of data between clients. Any number of applications may be granted access through partner applications 24 in various implementations of the invention. Access to the data is controlled based on applications associated to a core (for example, a US core or an EU core) and further based on privacy data groups, that is, identified data or deidentified data. Partner applications 24 may be implemented as a shared application instance, or could be a separate application installation per client/core or even a shared application with dedicated accounts.

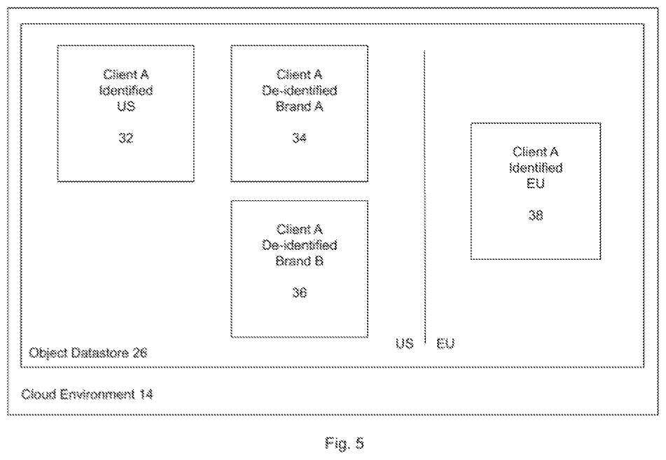

Compute resources controlled by clusters for data groups 16, 18, 20, and 22, as shown in FIG. 3, provide access to the actual client data stored in cloud 14 as one or more object store platforms based on data groups. In the example of FIG. 5, object datastore 26 consists of four different data cores. As illustrated, the data is bifurcated by a line between data that is physically stored in a location within the geographical boundaries of the EU, and data that is physically stored in a location within the geographical boundaries of the US. These are only examples, however, and any number of different regions may be used. In the data for client A at object datastore 26, there are separate categorial data storage areas for Client A's identified US data and EU data, and deidentified data that is separated into distinct categorial data groups for Client A's Brand A and Brand B. Core 32 is for Client A's identified US data; core 34 is for client A's de-identified data for Brand A, without regard to geographical location of the data; core 36 is for Client A's de-identified data for Brand B, without regard to geographical location of the data; and core 38 is for Client A's identified EU data. These cores 32, 34, 36, and 38 are stored in the geographical regions as shown in FIG. 5, although this is only one potential and simplified example, with access control being based on data group and assigned jobs and have restricted access based on the associated core. These are communicationally connected to the appropriate one of the compute resources controlled by data groups 16, 18, 20, and 22 as shown in FIG. 3, with proper authentication and authorization in place as set forth in access management 10.

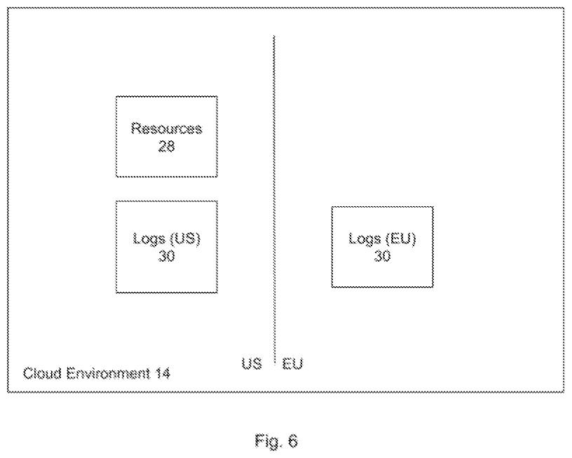

In addition to object datastore 26, there are also object datastores that contain shared resources and which, like object datastore 26, reside in cloud environment 14. For example, per-region logs 30 are maintained for each region, which in the example of FIG. 6 includes logs 30 for both the US and EU regions and which are physically stored in each of the corresponding regions but also stored within the cloud environment 14. On the other hand, resources 28 may be shared across regions, and while resources 28 are shown stored in the US region in FIG. 6, could be stored in any region where cloud environment 14 physically extends in various alternative implementations. Resources 28 is a read-only resource synched across all regions through a shared account, and used by those cores from storage within cloud environment 14 in the corresponding region. In this case, the difference is that resources 28 are used across all supported regions, and thus they are synched across all of these regions maintained by the system.

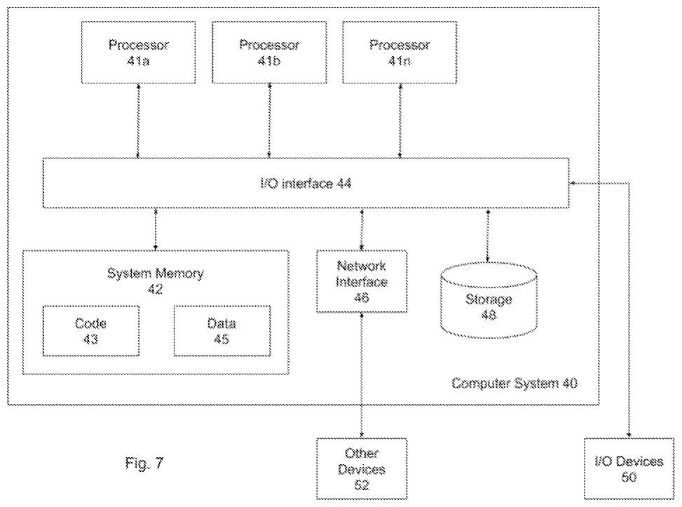

The methods described herein may in various embodiments be implemented by any combination of hardware and software. For example, in one embodiment, the methods may be implemented by a computer system (e.g., a computer system as in FIG. 7) or a collection of computer systems, each of which includes one or more processors executing program instructions stored on a computer-readable storage medium coupled to the processors. These computer systems may, for example, be used to implement the clusters 16, 18, 20, and 22 as described logically above. The program instructions may implement the functionality described herein (e.g., the functionality of various servers and other components that implement the network-based cloud and non-cloud computing resources described herein). The various methods as illustrated in the figures and described herein represent example implementations. The order of any method may be changed, and various elements may be added, modified, or omitted.

FIG. 7 is a block diagram illustrating an example computer system, according to various embodiments. Computer system 40 may implement a hardware portion of a cloud computing system or non-cloud computing system, as forming parts of the various implementations of the present invention. Computer system 40 may be any of various types of devices, including, but not limited to, a commodity server, personal computer system, desktop computer, laptop or notebook computer, mainframe computer system, handheld computer, workstation, network computer, a consumer device, application server, storage device, telephone, mobile telephone, or in general any type of computing node, compute node, compute device, and/or computing device.

Computer system 40 includes one or more processors 41a, 41b . . . 41n (any of which may include multiple processing cores, which may be single or multi-threaded) coupled to a system memory 42 via an input/output (I/O) interface 44. Computer system 40 further may include a network interface 46 coupled to I/O interface 44. In various embodiments, computer system 40 may be a single processor system including one processor 41a, or a multiprocessor system including multiple processors 41a, 41b . . . 41n as illustrated in FIG. 7. Processors 41a, etc. may be any suitable processors capable of executing computing instructions. For example, in various embodiments, processors 41a, etc. may be general-purpose or embedded processors implementing any of a variety of instruction set architectures. In multiprocessor systems, each of processors 41a, etc. may commonly, but not necessarily, implement the same instruction set. The computer system 40 also includes one or more network communication devices (e.g., network interface 46) for communicating with other systems and/or components over a communications network, such as a local area network, wide area network, or the Internet. For example, a client application executing on system 40 may use network interface 46 to communicate with a server application executing on a single server or on a cluster of servers that implement one or more of the components of the systems described herein in a cloud computing or non-cloud computing environment as implemented in various sub-systems. In another example, an instance of a server application executing on computer system 40 may use network interface 46 to communicate with other instances of an application that may be implemented on other computer systems.

In the illustrated embodiment, computer system 40 also includes one or more persistent storage devices 48 and/or one or more I/O devices 50. In various embodiments, persistent storage devices 48 may correspond to disk drives, tape drives, solid state memory, other mass storage devices, or any other persistent storage devices. Computer system 40 (or a distributed application or operating system operating thereon) may store instructions and/or data in persistent storage devices 48, as desired, and may retrieve the stored instruction and/or data as needed. For example, in some embodiments, computer system 40 may implement one or more nodes of a control plane or control system, and persistent storage 48 may include the SSDs attached to that server node. Multiple computer systems 40 may share the same persistent storage devices 48 or may share a pool of persistent storage devices, with the devices in the pool representing the same or different storage technologies.

Computer system 40 includes one or more system memories 42 that may store code/instructions 43 and data 45 accessible by processor(s) 41a, etc. The system memories 42 may include multiple levels of memory and memory caches in a system designed to swap information in memories based on access speed, for example. The interleaving and swapping may extend to persistent storage 48 in a virtual memory implementation. The technologies used to implement the memories 42 may include, by way of example, static random-access memory (RAM), dynamic RAM, read-only memory (ROM), non-volatile memory, or flash-type memory. As with persistent storage 48, multiple computer systems 40 may share the same system memories 42 or may share a pool of system memories 42. System memory or memories 42 may contain program instructions 43 that are executable by processor(s) 41a, etc. to implement the routines described herein. In various embodiments, program instructions 43 may be encoded in binary, Assembly language, any interpreted language such as Java, compiled languages such as C/C++, or in any combination thereof; the particular languages given here are only examples. In some embodiments, program instructions 43 may implement multiple separate clients, server nodes, and/or other components.

In some implementations, program instructions 43 may include instructions executable to implement an operating system (not shown), which may be any of various operating systems, such as UNIX, LINUX, Solaris™, MacOS™, or Microsoft Windows™. Any or all of program instructions 43 may be provided as a computer program product, or software, that may include a non-transitory computer-readable storage medium having stored thereon instructions, which may be used to program a computer system (or other electronic devices) to perform a process according to various implementations. A non-transitory computer-readable storage medium may include any mechanism for storing information in a form (e.g., software, processing application) readable by a machine (e.g., a computer). Generally speaking, a non-transitory computer-accessible medium may include computer-readable storage media or memory media such as magnetic or optical media, e.g., disk or DVD/CD-ROM coupled to computer system 40 via I/O interface 44. A non-transitory computer-readable storage medium may also include any volatile or non-volatile media such as RAM or ROM that may be included in some embodiments of computer system 40 as system memory 42 or another type of memory. In other implementations, program instructions may be communicated using optical, acoustical or other form of propagated signal (e.g., carrier waves, infrared signals, digital signals, etc.) conveyed via a communication medium such as a network and/or a wired or wireless link, such as may be implemented via network interface 46. Network interface 46 may be used to interface with other devices 52, which may include other computer systems or any type of external electronic device.

In some embodiments, system memory 42 may include data store 45, as described herein. In general, system memory 42, persistent storage 48, and/or remote storage accessible on other devices 52 through a network may store data blocks, replicas of data blocks, metadata associated with data blocks and/or their state, database configuration information, and/or any other information usable in implementing the routines described herein.

In one embodiment, I/O interface 44 may coordinate I/O traffic between processors 41a, etc., system memory 42 and any peripheral devices in the system, including through network interface 46 or other peripheral interfaces. In some embodiments, I/O interface 44 may perform any necessary protocol, timing or other data transformations to convert data signals from one component (e.g., system memory 42) into a format suitable for use by another component (e.g., processors 41a, etc.). In some embodiments, I/O interface 44 may include support for devices attached through various types of peripheral buses, such as a variant of the Peripheral Component Interconnect (PCI) bus standard or the Universal Serial Bus (USB) standard, for example. Also, in some embodiments, some or all of the functionality of I/O interface 44, such as an interface to system memory 42, may be incorporated directly into processor(s) 41a, etc.

Network interface 46 may allow data to be exchanged between computer system 40 and other devices attached to a network, such as other computer systems (which may implement one or more storage system server nodes, primary nodes, read-only node nodes, and/or clients of the database systems described herein), for example. In addition, I/O interface 44 may allow communication between computer system 40 and various I/O devices 50 and/or remote storage 48. Input/output devices 50 may, in some embodiments, include one or more display terminals, keyboards, keypads, touchpads, scanning devices, voice or optical recognition devices, or any other devices suitable for entering or retrieving data by one or more computer systems 40. These may connect directly to a particular computer system 40 or generally connect to multiple computer systems 40 in a cloud computing environment, grid computing environment, or other system involving multiple computer systems 40. Multiple input/output devices 50 may be present in communication with computer system 40 or may be distributed on various nodes of a distributed system that includes computer system 40. In some embodiments, similar input/output devices may be separate from computer system 40 and may interact with one or more nodes of a distributed system that includes computer system 40 through a wired or wireless connection, such as over network interface 46. Network interface 46 may commonly support one or more wireless networking protocols (e.g., Wi-Fi/IEEE 802.11, or another wireless networking standard). Network interface 46 may support communication via any suitable wired or wireless general data networks, such as other types of Ethernet networks, for example. Additionally, network interface 46 may support communication via telecommunications/telephony networks such as analog voice networks or digital fiber communications networks, via storage area networks such as Fibre Channel SANs, or via any other suitable type of network and/or protocol. In various embodiments, computer system 40 may include more, fewer, or different components than those illustrated in FIG. 7 (e.g., displays, video cards, audio cards, peripheral devices, or an Ethernet interface).

It is noted that any of the distributed system embodiments described herein, or any of their components, may be implemented as one or more network-based services in the cloud computing environment. For example, a read-write node and/or read-only nodes within the database tier of a database system may present database services and/or other types of data storage services that employ the distributed storage systems described herein to clients as network-based services. In some embodiments, a network-based service may be implemented by a software and/or hardware system designed to support interoperable machine-to-machine interaction over a network. A web service may have an interface described in a machine-processable format, such as the Web Services Description Language (WSDL). Other systems may interact with the network-based service in a manner prescribed by the description of the network-based service's interface. For example, the network-based service may define various operations that other systems may invoke, and may define a particular application programming interface (API) to which other systems may be expected to conform when requesting the various operations.

In various embodiments, a network-based service may be requested or invoked through the use of a message that includes parameters and/or data associated with the network-based services request. Such a message may be formatted according to a particular markup language such as Extensible Markup Language (XML), and/or may be encapsulated using a protocol such as Simple Object Access Protocol (SOAP). To perform a network-based services request, a network-based services client may assemble a message including the request and convey the message to an addressable endpoint (e.g., a Uniform Resource Locator (URL)) corresponding to the web service, using an Internet-based application layer transfer protocol such as Hypertext Transfer Protocol (HTTP).

In some embodiments, network-based services may be implemented using Representational State Transfer (REST) techniques rather than message-based techniques. For example, a network-based service implemented according to a REST technique may be invoked through parameters included within an HTTP method such as PUT, GET, or DELETE.

Unless otherwise stated, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein. It will be apparent to those skilled in the art that many more modifications are possible without departing from the inventive concepts herein.

All terms used herein should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. When a Markush group or other grouping is used herein, all individual members of the group and all combinations and subcombinations possible of the group are intended to be individually included. All references cited herein are hereby incorporated by reference to the extent that there is no inconsistency with the disclosure of this specification. When a range is stated herein, the range is intended to include all sub-ranges within the range, as well as all individual points within the range. When “about,” “approximately,” or like terms are used herein, they are intended to include amounts, measurements, or the like that do not depart significantly from the expressly stated amount, measurement, or the like, such that the stated purpose of the apparatus or process is not lost.

The present invention has been described with reference to certain preferred and alternative embodiments that are intended to be exemplary only and not limiting to the full scope of the present invention, as set forth in the appended claims.

1. A compute system for managing data privacy, the system comprising:
a. a compute management platform, wherein the compute platform comprises a plurality of compute data groups; and
b. a cloud storage platform, wherein the cloud platform comprises a plurality of data store cores, wherein at least one of the plurality of data store cores is physically located in a first geographical location and comprises data exclusively collected in the first geographical location, and at least one of the plurality of data store cores is physically located in a second geographically location remote from the first geographical location and comprises data exclusively collected in the second location,
wherein one of the plurality of compute data groups is associated with the first geographical location and such one of the compute data groups is configured to only allow access from such one of the compute data groups to one of the data store cores physically located in the first geographical location, and further wherein one of the plurality of compute data group sis associated with the second geographical location and such one of the compute data groups is configured to only allow access from such one of the compute data groups to one of the data store cores physically located in the second geographical location.

2. The system of claim 1, wherein each of the compute data groups in the compute management platform comprises a management routine providing data access to a plurality of users, each of the users associated with one of a plurality of cloud computing accounts, and wherein the access management routine is configured to provide access to each of the plurality of users to a subset of the compute data groups.

3. The system of claim 2, wherein a first cloud computing account is associated with the at least one of the plurality of data store cores that is physically located in the first location and a second cloud computing account is associated with the at least one of the plurality of data store cores that is physically located in the second location.

4. The system of claim 3, further comprising an access management routine comprising a list of the plurality of users and for each user a corresponding set of access privileges.

5. The system of claim 4, wherein at least one of the plurality of data store cores comprises a set of exclusively identified data or a set of exclusively de-identified data.

6. The system of claim 5, wherein at least one of the plurality of data store cores comprises data pertaining exclusively to a first line of business and at least one of the other data store cores comprises data pertaining exclusively to a second line of business.

7. The system of claim 6, further comprising a set of partner applications, wherein each partner applications of the set of partner applications is communicationally connected to at least one of the compute data groups and is configured to access and process data in at least one of the data store cores through access to the at least one of the compute data groups.

8. The system of claim 7, further comprising a resource data store comprising a set of resources communicationally connected for access by a plurality of the compute data groups.

9. The system of claim 8, further comprising a set of data store logs communicationally connected for access by a plurality of the compute data groups.

10. The system of claim 9, wherein a data store log is maintained in the set of data store logs for each location associated with a data store core.

11. A method of managing data privacy in a cloud computing architecture, the method comprising the steps of:
a. creating a first data store core in a cloud storage environment, wherein the first data store core is physically located in a first geographical region;
b. creating a second data store core in the cloud storage environment, wherein the second data store core is physically located in a second geographical region;
c. collecting a first set of data concerning objects associated with the first geographical region, and storing the first set of data exclusively in the first data store core;
d. collecting a second set of data concerning objects associated with the second geographical region, and storing the second set of data exclusively in the second data store core;
e. creating a first compute data group in a compute platform, wherein the first compute data group exclusively controls communication with the first data store core;
f. creating a second compute data group in the compute platform, wherein the second compute data group exclusively controls communications with the second data store; and
g. creating an access management routine comprising a set of users and associated access authorizations for each user in the set of users.

12. The method of claim 11, further comprising the step of associating at least one of the first and second data store cores exclusively with a set of identified data or a set of de-identified data.

13. The method of claim 11, further comprising the step of associated at least one of the first and second data store cores exclusively with a set of data pertaining to a first line of business and associating the other of the first and second data store cores exclusively with a set of data pertaining to a second line of business.

14. The method of claim 11, further comprising the step of associating each of the first and second data store cores exclusively with identified or de-identified data, or exclusively with a particular line of business, or exclusively with a particular geographic region.
